(19) United States
(12) Patent Application Publication
(10) Pub. No.: US 2016/0266390 A1
(43) Pub. Date: Sep. 15, 2016

(54) HEAD-UP DISPLAY AND CONTROL METHOD THEREOF

(71) Applicant: HYUNDAI MOBIS CO., LTD., Seoul (KR)

(72) Inventors: Jung Hoon SEO, Seoul (KR); Sang Hoon HAN, Seoul (KR); Chul Hyun LEE, Yongin-si (KR); Uhn Yong SHIN, Yongin-si (KR); Chan Young YOON, Gwangmyeong-si (KR)

(21) Appl. No.: 15/068,260

(22) Filed: Mar. 11, 2016

(30) Foreign Application Priority Data
Mar. 11, 2015 (KR) 10-2015-0033834
Dec. 11, 2015 (KR) 10-2015-0176696

(51) Int. Cl. G02B 27/01; G09G 3/02

(52) U.S. Cl. CPC G02B 27/0179; G02B 27/0101; G09G 3/02; G02B 2027/014; G02B 2027/0183; G02B 2027/0185

(57) ABSTRACT

A head up display (HUD) may include: a control unit configured to determine contents to be projected on the visible area of a driver and the projection position of the contents; a picture generation unit (PGU) configured to output a picture according to control of the control unit; and an optical system configured to change an optical path of the picture outputted from the PGU so as to project the picture on the visible area of the driver. The optical system may divide the output picture into two or more pictures having different projection distances, and project the pictures.

### CROSS-REFERENCES TO RELATED APPLICATIONS

The present application claims priority to Korean application number 10-2015-0033834, filed on Mar. 11, 2015 and Korean application number 10-2015-0176696, filed on Dec. 11, 2015, which is incorporated by reference in its entirety.

### BACKGROUND

The present disclosure relates to a head up display (HUD) and a control method thereof.

With the development of electronic devices, the functions for performance or safety of vehicles have been improved, and various devices for drivers' convenience have been developed. In particular, much attention has been paid to an HUD for a vehicle.

The HUD refers to a device which is designed to display operation information on the windshield of a vehicle or airplane. In the early days, the HUD has been introduced to secure the forward visual field of a pilot. Recently, however, the HUD has also been introduced in a vehicle, in order to reduce an accident.

The related technology is disclosed in Korean Patent No. 10-1361095 published on Feb. 4, 2014.

### SUMMARY

Embodiments of the present invention are directed to an HUD capable of forming a plurality of image zones having different focal distances, and a control method thereof.

In one embodiment, an HUD may include: a control unit configured to determine contents to be projected on the visible area of a driver and a projection position of the contents; a picture generation unit (PGU) configured to output a picture according to control of the control unit; and an optical system configured to change an optical path of the picture outputted from the PGU so as to project the picture on the visible area of the driver. The optical system may divide the output picture into two or more pictures having different projection distances, and project the pictures.

The optical system may include an aspheric mirror for determining the projection distances and magnifications of the projected pictures, and the aspheric mirror may be divided into two or more active regions having different aspheric coefficients.

The optical system may include screens corresponding to the two or more active regions, respectively.

The active region may include a first active region for forming an image zone at the lower part of the visible area of the driver and a second active region for forming an image zone at the top of the image zone formed by the first active region.

The projection distance of the first active region may be smaller than the projection distance of the second active region.

The magnification of the first active region may be larger than the magnification of the second active region.

The magnification of the first active region and the magnification of the second active region may be different values, such that the sizes of the pictures seen by the driver are adjusted to a same size.

The PGU may output a picture through a projection method using a digital micromirror device or liquid crystal.

The PGU may have an f-number corresponding to the range of asphericities of the aspheric mirror.

The PGU may have an f-number corresponding to the range of a changed projected distance.

The optical system may include a tiltable screen.

The control unit may correct a picture outputted from the PGU according to the angle of the screen.

The HUD may further include a vehicle speed sensor configured to measure the speed of the vehicle. The control unit may determine the projection position of the contents based on the speed measured through the vehicle speed sensor.

When the measured speed is equal to or more than a reference speed, the control unit may control the PGU to project additional information through the first active region and to project driving information through the second active region, and when the measured speed is less than the reference speed, the control unit may control the PGU to project the driving information through the first active region and to project the additional information through the second active region.

The PGU may output a picture through a laser scanning method.

In another embodiment, a control method of an HUD may include: measuring, by a control unit, speed of a vehicle; determining, by the control unit, contents to be projected on the visible area of a driver and the projection position of the contents, based on the measured speed; and outputting, by the control unit, a picture according to the result of the determining of the contents and the projection position of the contents.

In the determining of the contents and the projection position of the contents, when the measured speed is equal to or more than a reference speed, the control unit may determine to project additional information on the lower part of the visible area of the driver and to project driving information at the top of the lower part of the visible area of the driver, and when the measured speed is less than the reference speed, the control unit may determine to project the driving information on the lower part of the visible area of the driver and to project the additional information at the top of the lower part of the visible area of the driver.

### BRIEF DESCRIPTION OF THE DRAWINGS

FIG. 1 is a photograph for describing a state in which a HUD projects a picture.

FIG. 2 is a block diagram illustrating the configuration of an HUD in accordance with an embodiment of the present invention.

FIG. 3 is a diagram for describing an aspheric mirror of an example of an HUD.

FIG. 4 is a diagram for describing an aspheric mirror of the HUD in accordance with the embodiment of the present invention.

FIG. 5 is a photograph for describing a state in which the HUD in accordance with the embodiment of the present invention projects a picture.

FIG. 6 is a diagram for describing the configuration and operation of the HUD in accordance with the embodiment of the present invention.

FIG. 7 is another diagram for describing the configuration and operation of the HUD in accordance with the embodiment of the present invention.

FIG. 8 is a diagram for describing an image correction operation in the HUD in accordance with the embodiment of the present invention.

FIG. 9 is a flowchart for describing a control method of an HUD in accordance with an embodiment of the present invention.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

A HUD for a vehicle displays various pieces of vehicle operation, such as arrow information for guiding a path in connection with a navigation system and text information for indicating speed or the like, on the windshield or in the form of augmented reality beyond the windshield, thereby helping a driver to fix his/her eyes on the windshield.

That is, in order to check the vehicle information, the driver does not need to avert his/her eyes toward a terminal for providing the corresponding information. Furthermore, the driver can drive while watching the front side at which an HUD picture is outputted. Thus, the HUD contributes to the safety of the driver.

In one example of the HUD, the HUD projected a picture on a preset specific position. Thus, the picture might be hidden when the viewpoint of the driver is changed, or the viewing angle of the driver might be limited by the picture.

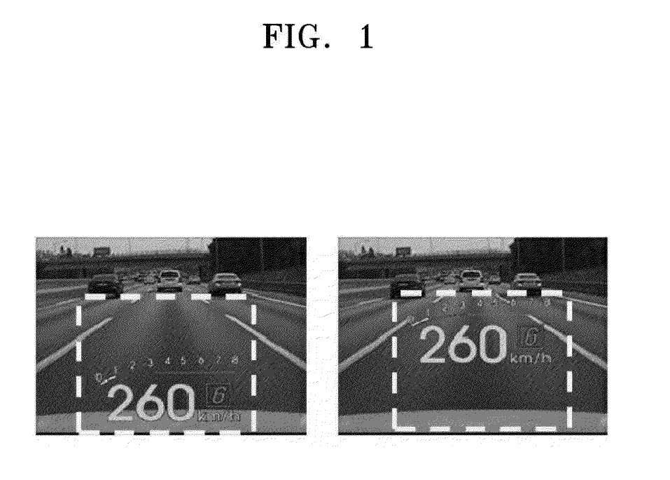

In another example of an HUD illustrated in FIG. 1, a HUD can control the level of a projected picture according to a change in viewpoint of a driver or the taste of the driver. In FIG. 1, a dotted line represents an image zone. The image zone indicates a region in which a picture projected by the HUD can be clearly maintained. That is, when the position of the projected picture deviates from the image zone, the picture seems to be distorted. Thus, the HUD moves the position of the projected picture only within the image zone.

In general, the size, shape, and position of the image zone are determined by an aspheric mirror included in an optical system of the HUD. That is, the size, shape, and position of the image zone are determined according to the size, installation position, curvature, rotation angle of the aspheric mirror. Furthermore, according to the characteristics of the aspheric mirror, the installation positions of the other components of the optical system are determined. Thus, the projection distance of a picture projected on the image zone may also be determined by the aspheric mirror.

However, since the HUD can form only one image zone, the projection distance of a projected picture cannot be changed within the image zone even though the position of the projected picture can be changed.

That is, the driver changes the focal position as well as the position of the gaze while driving the vehicle, but the HUD projects a picture at a fixed focal distance (fixed projection distance). Thus, the picture may interfere with the visual field of the driver.

In other words, when the driver gazes into the distance, the position of the driver's gaze becomes higher than when the driver gazes at a near object. Furthermore, the focal distance becomes larger than the driver gazes at a near object. However, the HUD can only move the position of the projected picture upward, but cannot change the focal distance of the projected picture. Thus, a difference may occur between the focal distance of the driver and the focal distance of the projected picture, and the visual field of the driver may be disturbed.

To address the foregoing, two HUDs having different focal distances may be mounted on a vehicle. In this case, however, the installation cost may be increased, and the volume and weight of the HUD module may also be increased.

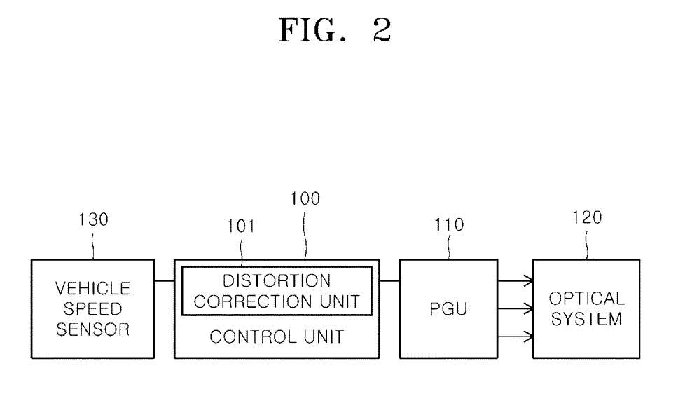

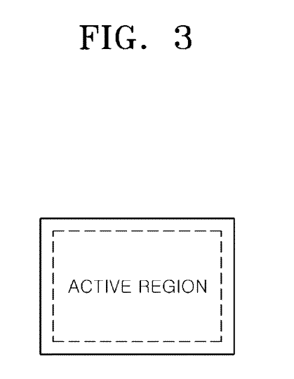

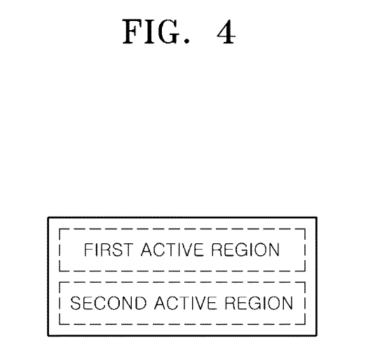

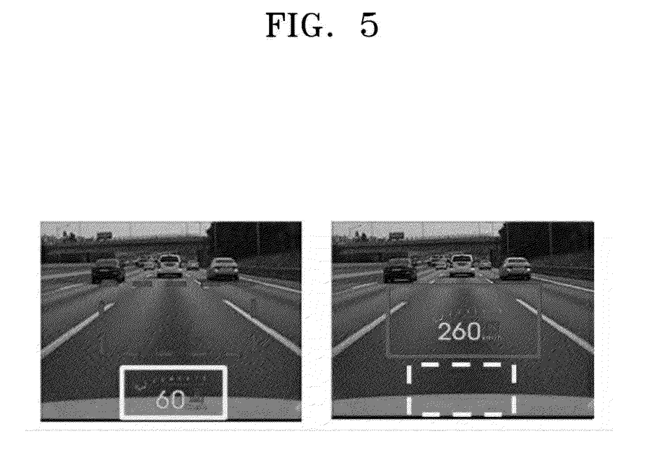

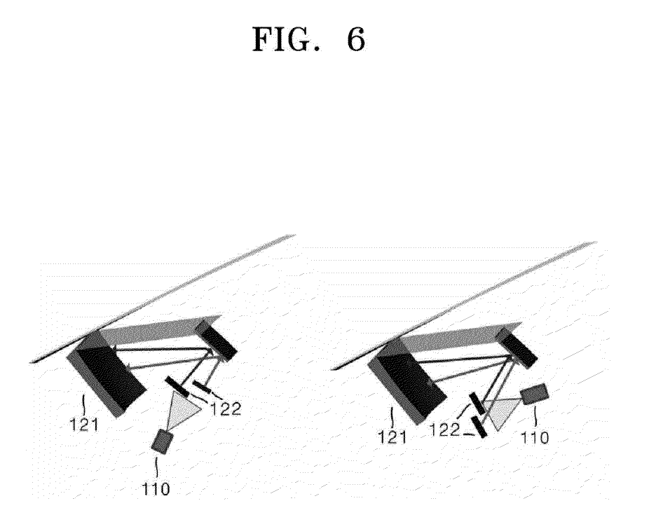

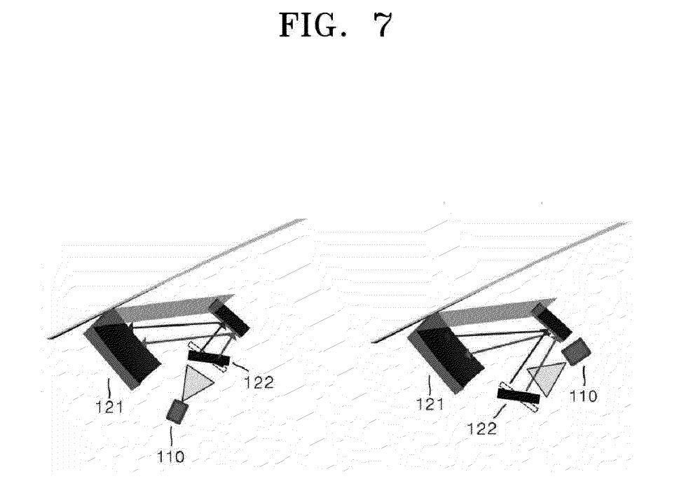

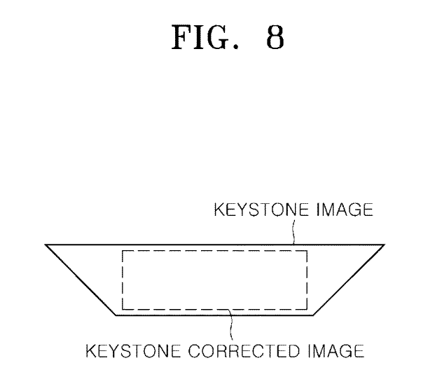

FIG. 2 is a block diagram illustrating the configuration of a head up display (HUD) in accordance with an embodiment of the present invention. FIG. 3 is a diagram for describing an aspheric mirror of an example of an HUD. FIG. 4 is a diagram for describing an aspheric mirror of the HUD in accordance with the embodiment of the present invention. FIG. 5 is a photograph for describing a state in which the HUD in accordance with the embodiment of the present invention projects a picture. FIG. 6 is a diagram for describing the configuration and operation of the HUD in accordance with the embodiment of the present invention. FIG. 7 is another diagram for describing the configuration and operation of the HUD in accordance with the embodiment of the present invention. FIG. 8 is a diagram for describing an image correction operation in the HUD in accordance with the embodiment of the present invention. Referring to FIGS. 2 to 8, the HUD in accordance with the embodiment of the present invention will be described as follows.

As illustrated in FIG. 2, the HUD in accordance with the embodiment of the present invention may include a control unit 100, a picture generation unit (PGU) 110, an optical system 120, and a vehicle speed sensor 130. In addition, the HDU may include a distortion correction unit 101.

The PGU 110 may output a picture according to control of the control unit 100. In embodiments, the control unit 100 may output a picture through the PGU 110 such that the picture is projected on a visible area of a driver.

The optical system 120 may change an optical path of the picture outputted from the PGU 110 so as to project the picture on the visible area of the driver. For example, the optical system 120 may include a plurality of mirrors to reflect the picture outputted from the PGU 110 onto the windshield of the vehicle.

Furthermore, the optical system 120 may divide the picture outputted from the PGU 110 into two or more pictures having different projection distances. In embodiments, the picture outputted from the PGU 110 and having one screen may be divided into two or more pictures having different projection distances through the optical system 120 and then projected on the windshield. Thus, the HUD in accordance with the embodiment of the present invention can project two or more pictures having different focal distances.

Since one picture outputted from the PGU 110 can be divided into two or more pictures having different projection distances, the PGU 110 needs to form a focus of the picture even though the projection distance is changed.

For example, the PGU 110 may out a picture using a laser scanning method. In embodiments, the PGU 110 may use a picture output method capable of forming a focus regardless of a projection distance.

For another example, the PGU 110 may use a projection method using a digital micromirror device or liquid crystal. In this case, the PGU 110 may be configured to have an f-number corresponding to the range of a changed projection distance.

In embodiments, while a DLP (Digital Light Processing) projector or LCOS (Liquid Crystal On Silicon) projector which is generally used is used as the PGU 110, the PGU 110 (or the PGU 110 and the optical system 120) may be configured to have an f-number corresponding to the range of the changed projection distance. Thus, although the projection distance is changed, the focus of the picture can be formed.

In embodiments, the focus depth of the optical system may be determined according to an equation of t=2NC(1+M) where t represents the depth of focus, N represents an f-number, C represents a pixel size, and M represents the magnification of an optical projection system. As indicated by the equation, the depth of focus may be increased when the f-number is raised. Thus, although the projection distance is changed, the projected image may not be blurred without losing focus. Thus, the PGU may be configured to have an f-number set to a sufficient magnitude which is capable of satisfying the changed projection distance.

The vehicle speed sensor 130 may measure the speed of the vehicle. For example, the vehicle speed sensor 130 may measure the speed of the vehicle by detecting the rotation of a transmission output shaft.

The optical system 120 may include an aspheric mirror 121 for determining the projection distance and magnification of a projected picture, and the aspheric mirror 121 may be divided into two or more active regions having different aspheric coefficients. The active region may indicate a region for forming one image zone. Referring to FIGS. 3 to 5, the active region will be described in more detail as follows.

As illustrated in FIG. 3, the aspheric mirror of an example of an HUD forms only one image zone as illustrated in FIG. 1, because the aspheric mirror has only one active region. As illustrated in FIG. 4, however, the aspheric mirror 121 of the HUD in accordance with the embodiment of the present invention can form a plurality of image zones as illustrated in FIG. 5, because the aspheric mirror 121 is divided into a plurality of active regions.

The division of the active regions may be performed by the shape of the aspheric mirror 121, and achieved as the aspheric mirror 121 is manufactured to have different aspheric coefficients (curvatures) for the respective active regions. Furthermore, according to the aspheric coefficients, the projection distances or magnifications of pictures projected on the image zones formed by the respective active regions may be changed.

For example, the active region of the aspheric mirror 121 may be divided into first and second active regions. The first active region forms an image zone at the bottom of the visible area of the driver (for example, a solid-line box of the left photograph and a dotted-line box of the right photograph in FIG. 5), and the second active region forms an image zone at the top of the image zone formed by the first active region (for example, a dotted-line box of the left photograph and a solid-line box of the right photograph in FIG. 5).

At this time, the projection distance of the first active region may be smaller than the projection distance of the second active region. In embodiments, the projection distance of the picture projected on the image zone formed by the second active region may be larger than the projection distance of the picture projected on the image zone formed by the first active region. In embodiments, the image zone formed by the second active region may be designed according to the focal distance and the visual field when the driver gazes into the distance, and the image zone formed by the first active region may be designed according to the focal distance and the visual field when the driver gazes at a near object.

The magnification of the first active region may be larger than the magnification of the second active region. In embodiments, the picture projected on the image zone formed by the second active region may have a longer projection distance than the picture projected on the image zone forming the first active region. Thus, although pictures having the same size are outputted and projected, the picture projected on the image zone formed by the second active region may look bigger than the picture projected on the image zone formed by the first active region, from the viewpoint of a driver. Therefore, the magnification of the second active region may be set to be smaller than the magnification of the first active region, such that the sizes of the pictures seen by the driver are adjusted to a similar size, which makes it possible to prevent the driver from feeling that the difference in size of the contents is changed as the driver varies his/her gaze.

Referring to FIGS. 6 to 8, such a picture projection process will be described in more detail as follows.

First, as illustrated in FIG. 6, the picture outputted from the PGU 110 may be transmitted to the aspheric mirror 121 through a screen 122 and a mirror. Then, the picture may be expanded by the aspheric mirror 121 and projected on the visible are of the driver.

In the present embodiment, since the aspheric mirror 121 can be divided into two or more active regions having different projection distances, the picture outputted from the PGU 110 may be divided into two or more pictures having different optical paths, and then transmitted to the aspheric mirror 121.

As illustrated in FIG. 6, the optical system 120 may include the screens 122 corresponding to the respective active regions, and any one of reflective and transparent screens can be employed as the screen 122.

In embodiments, the picture outputted from the PGU 110 may be separated into pictures having different optical paths through different screens 122, and the separated pictures may be reflected to the respective active regions of the aspheric mirror 121 through the mirrors. The reflected pictures may be expanded and reflected by the aspheric mirror 121 and projected on the windshield. As described above, the positions and sizes of the pictures projected on the respective active regions may be different from each other.

As illustrated in FIG. 7, the screen 122 can be tilted. In embodiments, the angle of the screen 122 may be adjusted to change the optical path of the picture outputted from the PGU 110. When the tiltable screen is employed, the aspheric mirror 121 may designed to have an asphericity which is successively changed. In embodiments, the aspheric mirror 121 may have a plurality of asphericities which are minutely changed.

In embodiments, the picture outputted from the PGU 110 may be reflected onto the active region of the aspheric mirror 121 through the screen 122 and the mirror. According to the angle of the screen 122, the position of the picture reflected onto the aspheric mirror 121 may be changed. In embodiments, the active region onto which the picture is reflected may be changed according to the angle of the screen 122. The reflected image may be expanded and reflected by the aspheric mirror 121 and projected on the windshield. As described above, the position and size of the projected picture may be changed at each of the active regions.

At this time, the angle of the screen 122 may be changed by the control unit 100 or another control device. As illustrated in FIG. 7, a reflective or transparent screen may be employed as the screen 122.

As such, when the screen 122 is tiltable, an actual projected image may be distorted (for example, keystone distortion), as illustrated in FIG. 8. Thus, the distortion correction unit 101 of the control unit 100 can correct the picture outputted from the PGU 110 according to the angle of the screen 122, and remove the distortion of the projected image.

The tiltable screen 122 may be applied to not only the case in which the PGU 110 uses a DLP projector or LCOS projector, but also the case in which the PGU uses a laser scanning method.

As illustrated in FIGS. 6 to 8, the optical paths of the projected pictures may be different at the respective active regions. Thus, the focal distances of the image zones formed by the respective active regions may also be different from each other. In embodiments, the HUD in accordance with the embodiment of the present invention may form a plurality of image zones using only a single PGU through the configuration of the optical system 120.

The control unit 100 may control the PGU 110 to correspond to the optical system 120, such that the HUD is smoothly operated. In embodiments, the control unit 100 may calculate and generate the shape of one picture such that the picture can be divided into a plurality of screens according to the separated optical paths, and output the generated shape through the PGU 110.

Furthermore, the control unit 100 may determine contents to be projected on the visible area of the driver and the projection position of the contents. In embodiments, the control unit 100 may determine contents to be displayed through the HUD, such as path information, vehicle speed, engine RPM, and fuel state, in connection with various systems of the vehicle, such as a navigation system and a cruise control system. Then, the control unit 100 may determine the position at which the contents are to be projected (the image zone on which the contents are to be projected and the position of the contents in the corresponding image zone).

For example, the control unit 100 may determine the projection position of the contents based on the speed of the vehicle, measured through the vehicle speed sensor 130. More specifically, when the measured speed is equal to or more than a reference speed, the control unit 100 may determine to project additional information at the lower part of the visible area of the driver and to project driving information at the top of the lower part of the visible area of the driver. When the measured speed is less than the reference speed, the control unit 100 may determine to project driving information at the lower part of the visible area of the driver and to project additional information at the top of the lower part of the visible region of the driver.

In embodiments, since the driver gazes into the distance as the speed of the vehicle is increased, the control unit 100 may project the driving information on the region at which the driver gazes, and project the additional information on the region at which the driver does not gaze. The driving information may indicate contents related to the operation of the vehicle, such as vehicle speed or information sign (for example, cooling water warning), and the additional information may indicate contents related to an additional function such as weather information.

Furthermore, since the HUD in accordance with the present embodiment can form a plurality of image zones having different focal distances, the control unit 100 may determine the projection position of the contents in consideration of the focal distance as well as the position of the driver's gaze.

In embodiments, when the measured speed is equal to or more than the reference speed, the control unit 100 may control the PGU 110 to project the driving information through the active region having the longest projection area. On the other hand, during low-speed operation (or when the measured speed is less than the reference speed), the viewing angle of the driver may be widened, and the focus of the driver may be close to the vehicle. Thus, the control unit 100 may display various pieces of information through the plurality of active regions.

In embodiments, the control unit 100 may determine the focal distance and the gaze position of the driver, based on the speed of the vehicle. Through the focal distance and the gaze position of the driver, the control unit 100 may set the display position of main information such that the driver can rapidly recognize the main information of the vehicle.

In the present embodiment, since the PGU 110 can output a picture through the laser scanning method, the control unit 100 may enable the driver to distinguish from the gap between the image zones, formed by turning off laser diodes between the respective active regions. Similarly, in the active region on which the additional information is to be displayed, the control unit 100 may turn off laser diodes such that the picture is not projected on the corresponding image zone.

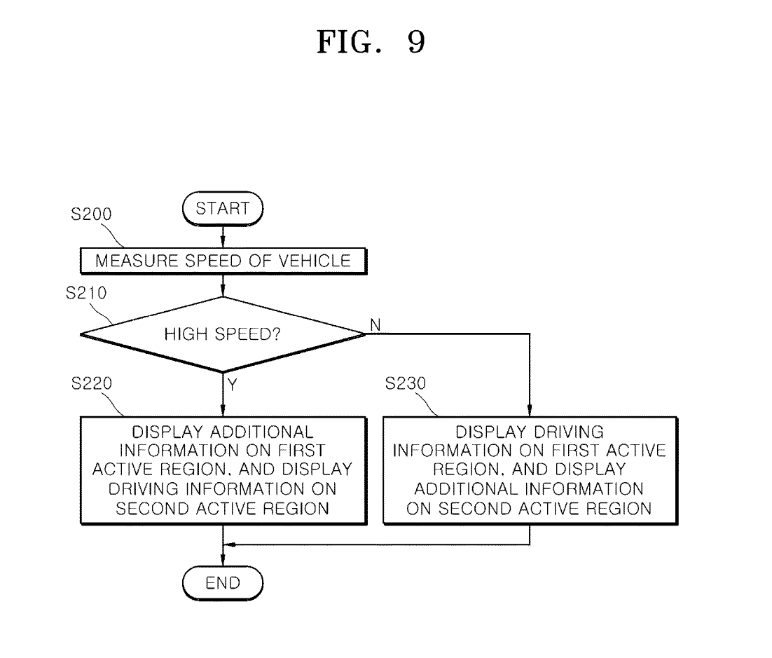

FIG. 9 is a flowchart for describing a control method of an HUD in accordance with an embodiment of the present invention. Referring to FIG. 9, the control method in accordance with the embodiment of the present invention will be described as follows.

As illustrated in FIG. 9, the control unit 100 may measure the speed of the vehicle at step S200. In embodiments, since a driver changes his/her gaze when the speed of the vehicle is increased, the control unit 100 may measure the speed of the vehicle to determine the display position of contents.

Then, the control unit 100 may determine whether the speed measured at step S220 is high, at step S210. For example, when the vehicle speed is equal to or higher than the reference speed, the control unit 100 may determine that the vehicle speed is high.

When it is determined at step S210 that the vehicle speed is high, the control unit 100 may output a picture such that additional information is displayed on the first active region and driving information is displayed on the second active region, at step S220. In embodiments, since the driver gazes into the distance when the speed of the vehicle is increased, the control unit 100 may control the PGU 110 to project the driving information on the region at which the driver gazes, and control the PGU 110 to project the additional information on the region at which the driver does not gaze.

On the other hand, when it is determined at step S210 that the vehicle speed is not high, the control unit 100 may output the picture such that the driving information is displayed on the first active region and the additional information is displayed on the second active region, at step S230.

As such, the HUD and the control method thereof in accordance with the embodiment of the present invention may form the plurality of image zones and adjust the projection distances of contents at the positions of the respective image zones, such that the driver can recognize the information of the vehicle only by moving his/her gaze to the minimum. Furthermore, since the HUD and the control method thereof can form the plurality of image zones using one PGU and the optical system, the cost can be reduced in comparison to than when a plurality of PGUs are used. Furthermore, the HUD and the control method thereof can change the projection positions of the respective contents according to the speed of the vehicle, such that the driver can rapidly recognize the information of the vehicle.

Although embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A head up display (HUD) comprising:
a control unit configured to determine contents to be projected on the visible area of a driver and a projection position of the contents;
a picture generation unit (PGU) configured to output a picture according to control of the control unit; and
an optical system configured to change an optical path of the picture outputted from the PGU so as to project the picture on the visible area of the driver,
wherein the optical system divides the output picture into two or more pictures having different projection distances, and projects the pictures.

2. The HUD of claim 1, wherein the optical system comprises an aspheric mirror for determining the projection distances and magnifications of the projected pictures, and
the aspheric mirror is divided into two or more active regions having different aspheric coefficients.

3. The HUD of claim 2, wherein the optical system comprises screens corresponding to the two or more active regions, respectively.

4. The HUD of claim 2, wherein the active region comprises a first active region for forming an image zone at the lower part of the visible area of the driver and a second active region for forming an image zone at the top of the image zone formed by the first active region.

5. The HUD of claim 4, wherein the projection distance of the first active region is smaller than the projection distance of the second active region.

6. The HUD of claim 4, wherein the magnification of the first active region is larger than the magnification of the second active region.

7. The HUD of claim 4, wherein the magnification of the first active region and the magnification of the second active region are different values, such that the sizes of the pictures seen by the driver are adjusted to a same size.

8. The HUD of claim 2, wherein the PGU outputs a picture through a projection method using a digital micromirror device or liquid crystal.

9. The HUD of claim 8, wherein the PGU has an f-number corresponding to the range of a changed projected distance.

10. The HUD of claim 8, wherein the PGU has an f-number corresponding to the range of asphericities of the aspheric mirror.

11. The HUD of claim 8, wherein the optical system comprises a tiltable screen.

12. The HUD of claim 11, wherein the control unit corrects a picture outputted from the PGU according to the angle of the screen.

13. The HUD of claim 1, further comprising a vehicle speed sensor configured to measure the speed of the vehicle,
wherein the control unit determines the projection position of the contents based on the speed measured through the vehicle speed sensor.

14. The HUD of claim 13, wherein the optical system comprises an aspheric mirror for determining the projection distances and magnifications of the projected pictures, the aspheric mirror is divided into two or more active regions having different aspheric coefficients, and the active region comprises a first active region for forming an image zone at the lower part of the vision area of the driver and a second active region for forming an image zone at the top of the image zone formed by the first active region.

15. The HUD of claim 14, wherein when the measured speed is equal to or more than a reference speed, the control unit controls the PGU to project additional information through the first active region and to project driving information through the second active region, and
when the measured speed is less than the reference speed, the control unit controls the PGU to project the driving information through the first active region and to project the additional information through the second active region.

16. The HUD of claim 1, wherein the PGU outputs a picture through a laser scanning method.

17. A control method of an HUD, comprising:
measuring, by a control unit, speed of a vehicle;
determining, by the control unit, contents to be projected on the visible area of a driver and a projection position of the contents, based on the measured speed; and
outputting, by the control unit, a picture according to the result of the determining of the contents and the projection position of the contents.

18. The control method of claim 17, wherein in the determining of the contents and the projection position of the contents,
when the measured speed is equal to or more than a reference speed, the control unit determines to project additional information on the lower part of the visible area of the driver and to project driving information at the top of the lower part of the visible area of the driver, and
when the measured speed is less than the reference speed, the control unit determines to project the driving information on the lower part of the visible area of the driver and to project the additional information at the top of the lower part of the visible area of the driver.
